(19) United States
(12) Patent Application Publication
(10) Pub. No.: US 2019/0084280 A1
(43) Pub. Date: Mar. 21, 2019

(54) METHOD FOR PRODUCING A FILLED FILM WEB

(71) Applicant: RKW SE, Frankenthal (Pfalz) (DE)

(72) Inventor: Ludwig Börmann, Babensham (DE)

(21) Appl. No.: 16/082,934

(22) PCT Filed: Mar. 22, 2017
(86) PCT No.: PCT/EP2017/056839

§ 371 Date: Sep. 7, 2018

(30) Foreign Application Priority Data
Mar. 22, 2016 (EP) 16161715.4

(51) Int. Cl. B32B 27/08; B29C 55/00; B29C 55/06; B29C 55/02; B29C 55/18; B29C 71/02; B32B 27/12; B32B 27/18; B32B 27/28; B32B 27/32; B32B 27/34; B32B 27/40; B32B 7/12

(52) U.S. Cl. CPC B32B 27/08; B32B 2038/0028; B29C 55/06; B29C 55/023; B29C 55/18; B29C 71/02; B32B 27/12; B32B 27/18; B32B 27/285; B32B 27/32; B32B 27/34; B32B 27/40; B32B 7/12; B29C 47/8845; B29C 55/005

(57) ABSTRACT

The invention relates to a process for producing a filled film web from a microporous starting film web of thermoplastic polymer material, which comprises at least one low-melting polymer component, one high-melting polymer component and a filler, the process comprising the following steps: heating of the microporous starting film web to a partly molten state in which at least one low-melting polymer component exists in a molten liquid state and at least one high-melting polymer component does not exist in the molten liquid state, and cooling down by passing the partly molten film web through a cooled roller nip. The invention further relates to the film web produced with the process as well as its use.

The invention relates to a process for producing a filled film web, a film web produced thereby, as well as its use, for example in the hygiene field.

In the context of environmental debates concerning conserving resources and sustainability, it is becoming of ever-increasing importance in the context of films, particularly of films for disposable products in the hygiene sector, to produce even thinner films than in the past, in order to save raw materials. On the other hand, the interest in filled and breathable films is increasing because they enable further saving of plastics.

From EP-A-0 768 168 and EP-A-1 716 830, processes for the manufacture of unfilled films usable in the hygiene field are known. Having regard to their field of use, such hygiene films are required to meet several requirements. They are to be liquid-impervious and have certain haptic properties, such as softness, flexibility, low-rustling performance and textile feel. Films in the hygiene field should have a soft, cloth-like feel. In particular, when to be used for incontinence products, they should give rise to as little noise as possible, that is to say, the films should have low rustling levels. In combination with a low shininess, this results in a very textile-like film, as is desirable in the hygiene field. An additional factor is that in recent years, the absorption bodies contained in diapers and incontinence products have become progressively thinner, made possible particularly by the use of super-absorber polymers. These super-absorber polymers are employed in the form of coarsely-particulate powders, and the hygiene films must be sufficiently strong to prevent with high certainty perforation of the film by the individual particles, e.g. when subjected to loads by sitting down or other movements of the wearer. A formation of punched holes (“pinholes”) due to super-absorber polymers and a bursting of the finished film products in the packaging units must be avoided. A further requirement for hygiene films resides in a minimum tensile strength as needed for processing the film webs in the very fast-running machines (converters) of the manufacturers of e.g. diapers and sanitary napkins. This minimum tensile strength is commonly specified in terms of 5%, 10% or 25% stretching in the machine direction (MD) or transverse direction (CD). At present, the tensile strength at 5% stretching (5%-modulus) in the machine direction should be at least 2.5 N/inch. In addition to that, films for hygiene uses should provide certain strengths, for example single-layered back sheets a longitudinal tearing strength of at least 10 N/inch and a transverse tearing strength of at least 5 N/inch. If the back sheet is laminated with a non-woven, the longitudinal tearing strength should at least be 5 N/inch and the transverse tearing strength at least 2 N/inch.

Methods for producing breathable films are, for example, known from EP 0 921 943 B1, EP 1 226 013 B1, EP 1 711 330 B1 and GB 2 364 512 B. Breathable films must satisfy the above requirements with regard to mechanical properties like unfilled films and must additionally be liquid-impervious. They are aimed at having low thicknesses as well. This can cause several problems.

To produce breathable films, films are filled with approximately 60% inert material and, after extrusion, subjected to a stretching process (usually stretching in the machine direction) in order to make the film breathable. As a filler, chalk (CaCO₃) is usually used in a particle size of 0.8-2 μm. During the stretching process, the elastic polymer portions of the film are stretched and pores are formed at the edge of the chalk granules toward the polymer matrix. Due to the scattering of the chalk particle sizes (up to 12 μm and larger), there are also always created pore sizes which can lead to leakage problems. This problem is exacerbated if for the production of breathable films that are as thin as possible, relatively high stretching levels of e.g. 2:1 to 3:1 are necessary. In some cases, films stretched in the machine direction also show low security against leakage. There is also the risk that the pores produced become too large (>1 μm) at some points in the film and thus a problem of soaking occurs (i.e. that liquid penetration resistance values (liquid impact values) greater than 3 g/m² are present). Values for the liquid penetration resistance of less than 2 g/m² or even less than 1.5 g/m² are desirable.

It is known that the films have a so-called memory effect. This means that films which have been stretched at, for example, 80° C. and subsequently subjected to an annealing at 100° C. try to shrink when these temperatures are reached again, for example with very hot hotmelt adhesives (about 160° C.) in the converter. This problem occurs precisely in chalk-filled films because of their good thermal conductivity and in particularly thin films. If the temperature is too high or if the film thickness is too low, undesirable holes (the so-called burn-through effect) can very quickly occur.

Usually, breathable films are nowadays temporarily stored for a few days after the stretching process, and the post-crystallization is awaited before further processing such as printing is carried out because the films can shrink subsequently. Therefore, if a film is to be printed, a crystallization time of about 1 to 3 days must be waited after the stretching process and before the printing process. This process causes very high costs and hinders inline printing of the films.

Filled and stretched films tend to block on the finished rolls. Blocking means that the film layers adhere to each other due to post-shrinkage in such a way that difficulties occur during unwinding, for example that the film exhibits so-called spiral cracks. In the case of spiral cracks, the film partially adheres to the underlying film layer. This leads to tearing of the film during unwinding, which particularly affects the areas in the vicinity of the cutting mirror. Blocking is a problem especially during unwinding of thin films.

Films stretched in the machine direction (MD) have a low puncture resistance against sharp-edged super-absorber granules, which are commonly used in hygiene products for liquid absorption. Since these granules are often in direct contact with the film, pinholes and leakage may occur in the finished product. In addition, filled and MD-stretched films show low MD tear propagation strength and low MD tearing strength. The slightest damage on the roll end face or a slight blocking of the film on the roll can lead to tearing and tear propagation, resulting in spiral cracks.

The stretching process generally enhances the differences between thick and thin spots in the film and can additionally lead to edge thickening, also referred to as “neck-in”. Both effects cause so-called piston rings on the finished rolls. This means that during unwinding of these rolls, long edges or sagging are produced in the film, which may in turn lead to great difficulties in the conversion process (e.g. CD offset of the film). High degrees of stretching reinforce edge thickening (neck-in) of the film, post-shrinkage of the film after the stretching process and very low tear propagation strength of the film in the machine direction. Often, the rolls are also stored temporarily in so-called nut rolls and fed to a cutting reel only after the post-shrinkage (crystallization), in which they are then cut to the desired customer width. The post-shrinkage of the breathable films can cause a considerable layer pressure on the finished rolls, which may in turn cause blocking between the film layers and lead to spiral cracks during unwinding of the film.

Especially in back sheets (hacking layers for diapers and hygienic products), edge thickening effects, such as sagging and long film edges, cause great problems when entering the converters, since on the one hand the stretching process in the machine direction strongly intensifies thick and thin spots, and, on the other hand, an offset of the foils in the transverse direction (CD) may occur, which can ultimately lead to a standstill of the converter. For this reason, it is very important that hack sheets are flat when they enter converters.

In order to solve one or several of these problems, the present invention suggests heating a filled, microporous starting film web up to a partly molten state and then to cool it rapidly in a cooled roller nip. The filled microporous starting film web contains micropores. If the pores are connected, the film is breathable. Surprisingly, it has been found that the pores in filled breathable and filled non-breathable films do not close during the heating of the film into the partial molten liquid state, but remain. By the partly molten state and the subsequent cooling of the film, the properties of the film are significantly improved, and the above-mentioned problems are thus solved.

Thus, the invention relates to a process for producing a filled film web from a microporous starting film web of thermoplastic polymer material, which comprises at least one low-melting polymer component, one high-melting polymer component and a filler, the process comprising the following steps: heating of the microporous starting film web to a partly molten state in which at least one low-melting polymer component exists in a molten liquid state and at least one high-melting polymer component does not exist in the molten liquid state, and cooling down by passing the partly molten film web through a cooled roller nip.

The filled microporous starting film web may be breathable or non-breathable. In the present case, the term “microporous” means that essentially pores of a size of to 5 μm are present. Essentially means that at least 90% of the pores, preferably 95%, more preferably 99% of the pores, or even 99.9% of the pores have a size of 0.1 to 5 μm, and the remaining pores are somewhat larger, generally up to 15 μm.

The microporous starting film web could be multi-layered or multi-plied. In preferred embodiments, the microporous starting film web is a co-extruded film web. In other embodiments, the microporous starting film web is not co-extruded. In further embodiments, the microporous starting film web is a multi-layer or multi-ply, non-co-extruded film web.

In other embodiments, the microporous starting film web is single-layered.

In a preferred embodiment of the invention, the starting film web is stretched in the machine direction (MD) or in the transverse direction (CD), or in the machine and transverse direction. In another preferred embodiment, the starting film web has been stretched during the production, for example after its extrusion, at a stretching ratio of 1.2:1 to 4:1, in particular at 1.3:1 to 3.5:1 or 1.5:1 to 3:1.

Preferably, the microporous starting film web contains 10 to 90% by weight of filler, in particular 20 to 80% by weight of filler, preferably 30 to 75% by weight of filler, more preferably 50 to 60% by weight of filler, based on 100% by weight of the starting film web. In a preferred embodiment, the starting film web is breathable, In another preferred embodiment, the microporous starting film web is non-breathable. In another preferred embodiment, the film has a water vapor permeability within the range of from 500 to 5000 g/m² in 24 hours when measured according to ASTM E398 at 37.8° C. and 90% relative humidity. Values or ranges of values for the water vapor permeability given herein refer to this measuring method. For example, the measuring may be carried out with a Lyssy measuring device.

In further preferred embodiments, a starting film web comprising 15 to 85% by weight of low-melting polymer component and 85 to 15% by weight of high-melting polymer component, based on 100% by weight of low-melting and high-melting polymer components, is used. Preferably, a starting film web with at least one polyethylene serving as a low-melting polymer component and with at least one polypropylene serving as a high-melting polymer component is used.

In particular, heating of the starting film web takes place to 5 to 20° C. below the crystallite melting point of at least one high-melting polymer component. The heating of the starting film web is preferably performed by means of a heating cylinder, the temperature of the heating cylinder being chosen such that the to heating is carried out over the wrapping path of the heating cylinder.

In preferred embodiments, the microporous starting film web is heated by means of a heating cylinder, with no non-woven being present between the heating cylinder and the film web. In these embodiments, the film web is in direct contact with the heating cylinder. Embodiments are also possible in which there is no non-woven between the heating cylinder and the film web, and a non-woven web rests on the film web or is passed over it. In other preferred embodiments, the heating of the microporous starting film web is carried out by means of a heating cylinder in the absence of a non-woven. This means that there is no non-woven between the heating cylinder and the film web and no non-woven rests on the film web. In other embodiments with a non-woven, there is a non-woven between the heating cylinder and the film web.

In further preferred embodiments, the film web is subjected to cooling in the cooled roller nip to at least 10 to 30° C. below the crystallite melting point of at least one low-melting polymer component. Preferably, the cooled roller nip is formed by an embossing roller and a rubber roller. The film web may be printed after cooling.

In addition, the invention relates to the film webs produced with the described processes, for example with a basis weight of from 1 to 30 g/m², in particular from 5 to 25 g/m², preferably from 7 to 20 g/m², more preferably from 10 to 20 g/m², as well as their use, in particular in the hygiene or medical field, for example for back sheets in diapers, for mattress protectors or sanitary napkins. In addition, the invention relates to use of the produced film webs in the construction area, e.g. as cover films or as automobile protection films.

Preferred embodiments of the invention are described in the following description, the Figures, the example and the sub-claims.

The Figures show:

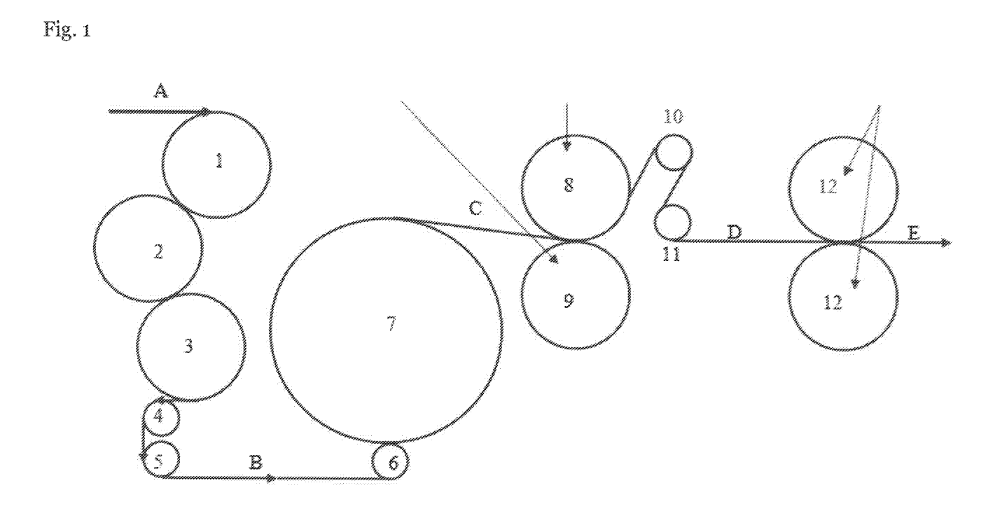

FIG. 1 shows a preferred embodiment for carrying out the process according to the invention.

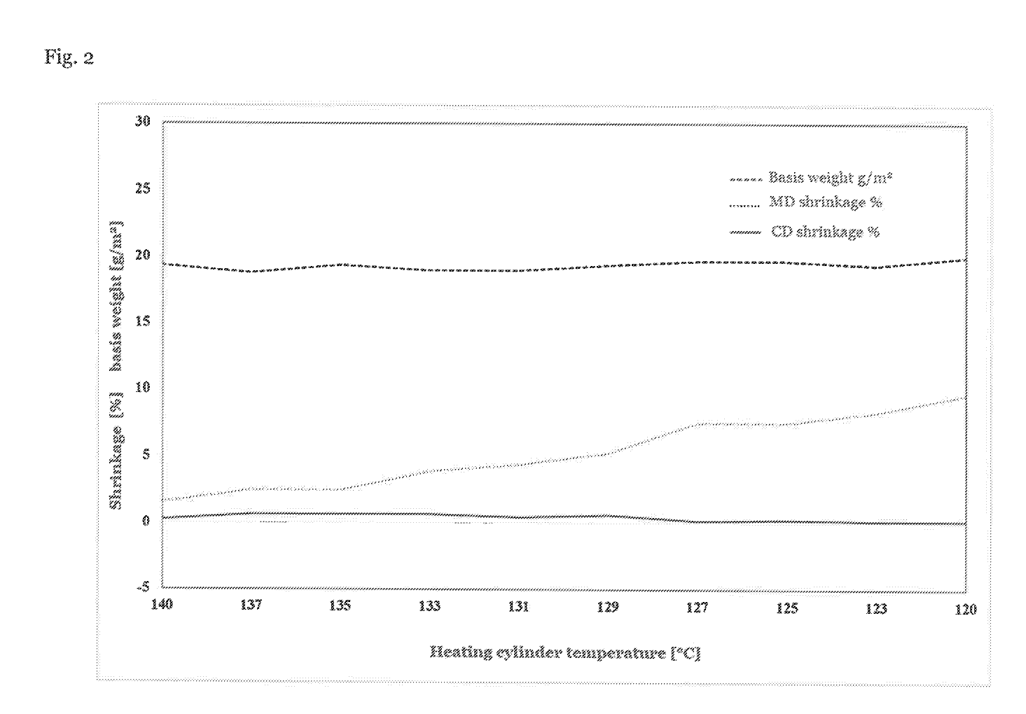

FIG. 2 shows the shrinkage and the basis weight of films as a function of their heating cylinder temperature.

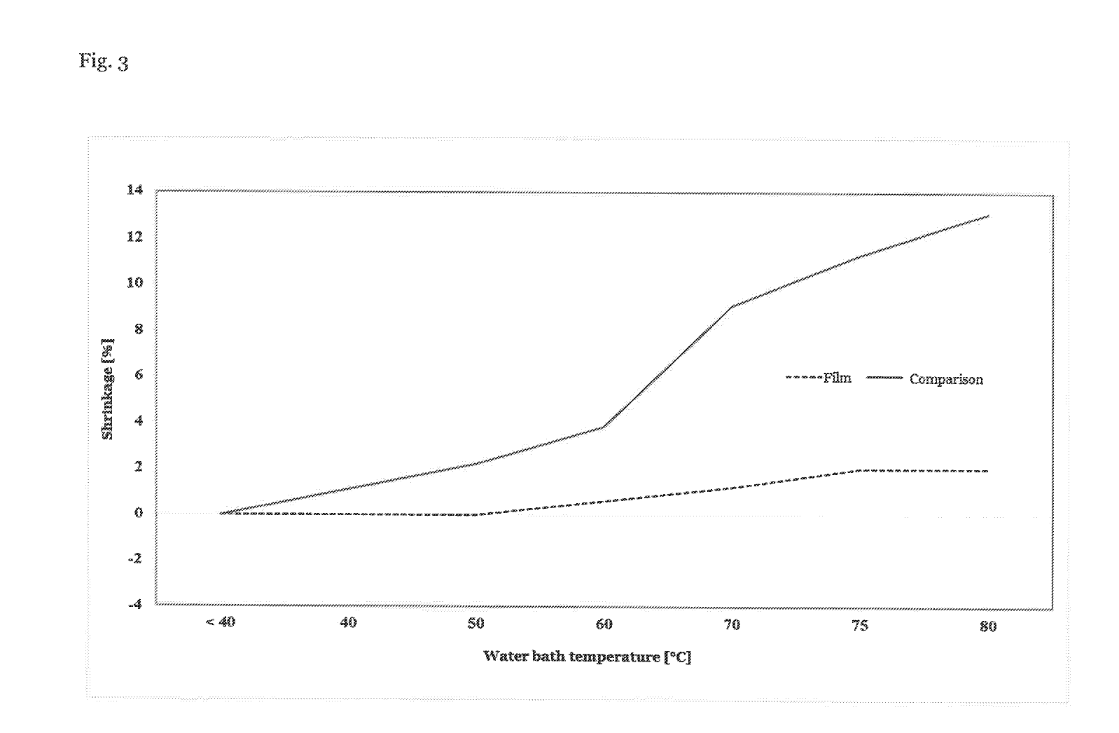

FIG. 3 shows the shrinkage for a film and a comparison film as a function of the water bath temperature.

In the present invention, the stated melting points, melting ranges and crystallite melting points refer to a determination according to DSC (Differential Scanning Calorimetry).

According to the invention, the starting film web contains or comprises at least one low-melting polymer component and at least one high-melting polymer component. In other words, the starting film web contains one or more low-melting polymer component(s) and one or more high-melting polymer component(s). The same meanings apply to the terms used below in the context of the invention “a low-melting polymer component” and “a high-melting polymer component”, i.e. these as well include one or more low-melting or respectively high-melting polymer component(s). Preferably, the starting film web contains one, or preferably two, low-melting polymer component(s). Preferably, it contains one, more particularly two, high-melting polymer component(s). In other embodiments of the invention, it contains preferably three low-melting polymer components and/or three high-melting polymer components. Whether a polymer material of the starting film web is to be considered a low-melting polymer component or a high-melting polymer component is determined according to the invention in terms of the respective crystallite melting point, melting point or melting range of the polymer material in relation to the heating temperature. At a given heating temperature, the liquid. molten polymer materials are assigned to the low-melting polymer component and the non-liquid molten polymer materials to the high-melting polymer component.

It is well known that polymers have no sharply-defined melting point, but a melting range, even though it is possible to assign a crystallite melting point to the crystalline regions of a polymer. This crystallite melting point is always higher than the melting point or melting range of the non-crystalline components. The molten liquid state is defined by the state in which the shear modulus approaches zero. In the case of polymers having crystalline regions, the latter are then no longer detectable. The shear modulus may, for example, be determined according to ISO 6721-1 & 2. In the present invention the starting film web is heated to a temperature at which the shear modulus of the low-melting polymer component is zero and for the high-melting polymer component the shear modulus is not zero. No crystalline regions are then detectable any more for the low-melting polymer component and the low-melting polymer component is present in its molten liquid state. On the other hand, for the high-melting polymer component, crystalline regions are still detectable, and it is below the molten liquid state. To summarize, the shear modulus of the whole polymer material of the starting film web is accordingly not zero and crystalline regions of the high-melting polymer component are still detectable. Accordingly, there now exists a partly-molten film web.

In principle, all thermoplastic polymers can be used, which have the appropriate melting points to serve as materials for the two polymer components of the starting film web. For this purpose, numerous commercial products are commercially available. Preferably, a variety of polyolefins, in particular polyethylenes, polypropylenes, copolymers of ethylene and propylene, co-polymers of ethylene and propylene with other comonomers, or mixtures thereof are employed. Furthermore, ethylene vinyl acetate (EVA), ethylene acrylate (EA), ethylene ethyl acrylate (EEA), ethylene acrylic acid (EAA), ethylene methyl acrylate (EMA), ethylene butyl acrylate (EBA), polyesters (PET), polyamides (PA), e.g. nylon, ethylene vinyl alcohols (EVOH), polystyrene (PS), polyurethane (PU), thermoplastic olefin elastomers or thermoplastic ether-ester block elastomers (TPE-E) are suitable.

The total amount of low-melting polymer component is preferably 90 to 10% by weight, in particular 90 to 20% by weight, preferably 80 to 30% by weight, more preferably 80 to 40% by weight, most preferably 70 to 50% by weight. The total amount of high-melting polymer component is preferably 10 to 90% by weight, in particular 10 to 80% by weight, preferably 20 to 70% by weight, more preferably 20 to 60% by weight, most preferably 30 to 50% by weight, each based on 100% by weight of low-melting and high-melting polymer components. In the alternative, the total amount of low-melting polymer component is preferably 85 to 5% by weight, in particular 75 to 25% by weight, and the total amount of high-melting polymer component is 15 to 85% by weight, in particular 25 to 75% by weight, again based on 100% by weight of low-melting and high-melting components. These quantitative data apply, for example, in the case of the low-melting polymer component to one or more polyethylene(s) and in the case of the high-melting polymer component to one or more polypropylene(s).

In a particularly preferred embodiment, the starting film web contains at least one polyethylene serving as the low-melting polymer component and at least one polypropylene serving as the high-melting polymer component.

Preferably, the low-melting polymer component contains ethylene polymers or consists of ethylene polymers, wherein both ethylene homopolymers as well as ethylene copolymers with ethylene as the main monomer as well as mixtures (blends) of ethylene homopolymers and ethylene co-polymers are suitable. Suitable ethylene homopolymers are LDPE (Low Density Polyethylene), LLDPE (Linear Low Density Polyethylene), MDPE (Medium Density Polyethylene) and HDPE (High Density Polyethylene). Preferred comonomers for ethylene copolymers are olefins other than ethylene with the exception of propylene, e.g. butene, hexene or octene. Preferably, in the case of the ethylene copolymers the comonomer content is below 20% by weight, in particular below 15% by weight. In a preferred embodiment, the low-melting polymer component consists exclusively of an ethylene homopolymer or mixtures of ethylene homopolymers, e.g. of LDPE and LLDPE, which each may be contained in amounts of 10 to 90% by weight, as well as 0 to 50% by weight of MDPE. Specific examples are a polyethylene composed of 60% by weight of LDPE and 40% by weight of LLDPE or a polyethylene of 80% by weight of LDPE and 20% by weight of LLDPE.

Besides, the ethylene homopolymers and/or ethylene copolymers, the low-melting polymer component may also contain other thermoplastic polymers. There are no limits to these thermoplastic polymers as long as, as a result thereof, the temperature at which the total low-melting polymer component exists in the molten liquid state does not approach too closely the temperature at which the high-melting polymer component would be in the molten liquid state. It is also possible for the low-melting polymer component to contain a polypropylene the melting point or melting range of which is not higher than that of an ethylene homopolymer or ethylene copolymer or which, although it is higher than these, is still lower than the heating temperature to be employed. As is well-known, there exists highly-crystalline isotactic, less crystalline syndiotactic and amorphous atactic polypropylene, which have different melting points, melting ranges or crystalline melting points. When using amorphous atactic polypropylene, which has a considerably lower melting point or melting range than isotactic and, in some cases, even syndiotactic polypropylene, such might, in certain cases, as a function of the heating temperature, be assigned to the low-melting polymer component.

Preferably, the high-melting polymer component contains at least one polypropylene, the melting point, melting range or crystallite melting point of which is substantially higher than that of the low-melting polymer component. A suitable polypropylene is, in particular, isotactic polypropylene. It is also possible to employ syndiotactic polypropylene, provided that its melting point, melting range or crystallite melting point is substantially higher than that of the low-melting polymer component. Suitable polypropylenes are commercially-available, for example for the manufacture of blown and/or cast films.

The high-melting polymer component may include both propylene homopolymers as well as propylene copolymers with propylene as the main monomer. In the case of propylene copolymers, the content in this context of comonomers, i.e. the non-propylene, is to be considered part of the low-melting or high-melting polymer component, depending on the other components and the heating temperature. Suitable co-monomers for propylene copolymers are Olefins other than propylene, preferably ethylene. In the case of propylene-ethylene-copolymers, the ethylene content preferably is 2 to 30% by weight, particularly preferably 2 to 20% by weight and in partichlar 2 to 15% by weight, in which context, in practice, very good results are attained at an ethylene content of 3 to 20% by weight. These numerical values also apply to other olefins.

Below, the melting ranges for some polyethylenes and polypropylenes are listed:

LDPE: 110-114° C.;

LLDPE: 115-130° C.;

HDPE: 125-135° C.;

Propylene-homopolymers: 150-165° C.,

Propylene-ethylene-copolymers: 120-162° C., even higher temperatures being go possible for very low ethylene contents;

Bimodal propylene-ethylene (homo)copolymers: 110-165° C.

It is also possible to use so-called bimodal polypropylenes. In this context, these are two different polypropylenes, each with a different copolymer content, combined in one raw material. Such bimodal polypropylene has two crystallite melting points, in which case, as a rule, the approximate contents of the two polypropylenes can also be determined by DSC-analysis. As an example, a bimodal polypropylene is cited having crystallite melting points at 125° C. and 143° C. with a content of the two different polypropylenes of 25/75. At a heating temperature of 130° C., according to the invention, the 25% polypropylene with a crystallite melting point at 125° C. would have to be assigned to the low-melting polymer component and the 75% polypropylene having a crystallite melting point at 143° C. would have to be assigned to the high-melting polymer component.

In a particular embodiment, a starting film web is used having the following polymer components: 25 to 80% by weight, in particular 25 to 60% by weight of an LLDPE, e.g. an ethylene-octene-copolymer with 5 to 15% by weight of octene content; 20 to 30% by weight of a propylene-ethylene-copolymer with 3 to 12% by weight of ethylene; and the balance LDPE; each based on 100% by weight of low-melting and high-melting polymer components.

Just as specific molten polypropylene can be found in the low-melting polymer component, it is also possible for a specific non-molten polyethylene to be found in the high-melting polymer component, which is then assigned to the high-melting polymer component. This is illustrated by the following example. A formulation suitable for a microporous starting film web comprises as polymer components: 30% by weight of LDPE (melting point 112° C.), 30% by weight of LLDPE (melting point 124° C.), 20% by weight of HDPE (melting point 130° C.) and 20% by weight of polypropylene (melting point 160° C.). If the film web is heated to a temperature of 126° C., the LDPE and LLDPE according to the invention are present in the molten liquid state, while not only the polypropylene, but also the HDPE are not in the molten liquid state.

The microporous starting film webs for carrying out the process of the invention may be produced by any method known in the prior art. For example, the starting film web may be produced by heating the polymer components and fillers in an extruder, e.g. a compounding extruder, to a temperature significantly higher than the melt flow temperature of the polymer components (e.g. above 200° C.), and fusing them. This is followed by a casting method, e.g. by means of a slit nozzle, or a blow method. These methods are known in the art. In the slot nozzle method, a film is extruded through a slot nozzle. The blowing method is preferred in which a blow tube or film bubble is formed. The formed tubular film can be laid flatly on top of each other and slit open at the ends so that two film webs are formed, each of which can be used as a starting film web.

To produce the microporosity of the starting film web, the extruded film can be subjected to a stretching process. It is possible to stretch in the machine direction (MD), the transverse direction (CD), or in the machine and transverse directions. In addition, ring rolling is also possible.

The starting film web can be stretched. Stretching or elongating a film means stretching the film in a given direction, resulting in a reduction in the film thickness. The film can be stretched in the machine or longitudinal direction (MD), for example by a stretching unit that contains two or more rollers, e.g. three rollers, which are driven at different speeds. The film can, for example, be stretched at a stretching ratio of 1:1.5, which means that the film thickness is reduced e.g. from 15 μm to 10 μm. It is also possible, to additionally subject the film to a transverse stretching (CD). Such biaxial stretching can be achieved, for example, by stretching machines available on the market, e.g. by the company Brückner. The used stretching ratio depends on the film formulation and the chosen process parameters and can be at least 1:1.2, preferably at least 1:1.5, in particular at least 1:2, more preferably 1:2.5, even more preferably 1:3, or at least 1:4.

The starting film web used according to the invention contains fillers. There are no limitations with regard to suitable fillers and they are known to the person skilled in the art. All materials are suitable which can be ground to a certain size, cannot melt in the extruder and cannot be stretched. Inorganic fillers are particularly suitable, such as chalk (calcium carbonate), day, kaolin, calcium sulfate (gypsum) or magnesium oxide. Synthetic fillers, such as carbon fibers, to cellulose derivatives, ground plastics or elastomers, are also suitable. Calcium carbonate or chalk are most preferred because of their reasonable price but also in the light of sustainability. The filler can have a particle size of e.g. 0.8 to 2 μm. If a filler of more uniform particle size than chalk is desired, it is also possible to use synthetic fillers of uniform particle size or particle size distribution. The film may contain a small amount of fillers, e.g. 5 to 45% by weight or from 10 to 50% by weight, so that pores are formed during the stretching process, which, however, are isolated and the film is not breathable. In order to attain breathability of the film, it is appropriate that at least 35% by weight of fillers, in particular at least 45% by weight of fillers, preferably at least 55% by weight of fillers, more preferably at least 65% by weight of fillers, based on 100% by weight of the total formulation of the starting film web including filler(s), are used. The upper limit with regard to fillers is determined in that pores are no longer formed but holes, or that the film tears off. Suitable film formulations with fillers can be determined by the person skilled in the art on a routine basis. A formulation containing 35 to 75% by weight, in particular 45 to 75% by weight of fillers, preferably 55 to 70% by weight of fillers, based on 100% by weight of starting film web, is particularly suited. Exemplary formulations for non-breathable films comprise 5 to 50% by weight, in particular 10 to 40% by weight of fillers, based on 100% by weight of starting film web. Exemplary formulations for breathable films comprise 35 to 80% by weight, in particular from 45 to 75% by weight of fillers, based on 100% by weight of starting film web. Care must be taken in this context not to choose the content of low-melting component so high that breathability is attained but lost again because the pores close again.

If the microporous starting film web is multi-plied and non-breathable, the filler can be located in one or more film layers of the starting web. If the microporous starting film web is multi-plied and breathable, the filler can be located in one or more film layers of the starting web, the amount of filler being selected in each film layer such that the film layer is breathable.

The microporous starting film web preferably has micropores in the size of 0.1 to 5 μm, in particular 0.1 to 3 μm or 0.2 to 1 μm. In addition, a few larger pores can also be present.

The starting film web may consist of one or a plurality of plies, it may thus be mono-extruded and co-extruded, respectively. There is no limitation with regard to the number of plies or layers used. One or more plies or layers may be present, e.g. one ply, two plies, three plies or four plies. For example, 5, 7 or 9 plies are also possible. The plies or layers may have identical or different formulations, in which context the assignment to the low- or high-melting polymer component is in each case determined by the crystallite melting point. The plies or layers may be produced by blown film extrusion or east extrusion. In the case of multi-plied starting film webs, at least one layer may be produced by blown film extrusion and at least one other layer by cast extrusion. There is no limitation with regard to the combination of blow-film extruded and/or cast-extruded films, film plies or film layers. There is no limitation with regard to the number of the co-extruded plies or layers.

In other embodiments, the starting film web is not co-extruded.

In exemplary embodiments, the starting film web may also be produced as described below:
blow-extruded, slit, on two separate webs or separate rolls;
blow-extruded, slit, on two or more separate webs at the same time;
blow-extruded, slit, laid fiat as a non-slit tube;
blow-extruded, slit into two or more separate webs coming from different extruders; or
cast-extruded into two or more separate webs at the same time.

It is also possible to produce the films in-line. In this case, a production step is available for the processes of extrusion and stretching (MDO, biaxial or ring rolling) as well as for the further processing (e.g. embossing and printing).

The starting film webs used in the process according to the invention may be dyed or pigmented, e.g. white with titanium dioxide. Furthermore, the starting film webs may contain conventional additives and processing aids. In particular, apart from the already mentioned fillers, this concerns pigments or other colorants, anti-adhesives, lubricants, processing aids, antistatic agents, germ-inhibiting agents (biocides), antioxidants, heat stabilizers, stabilizers with regard to UV-light or other agents for property modification. Typically, such substances, as in the case of fillers, are already added prior to the heating of the starting film web according to the invention, e.g. into the polymer melt during its manufacture or prior to extruding into a film.

The starting film web preferably has basis weights in the range below 50 g/m², in particular below 40 g/m², preferably below 30 g/m², more preferably below 20 g/m². Basis weights in the range below 10 g/m² or below 5 g/m² are also possible. Preferred basis weights are in the range of 1 to 30 g/m², 1 to 25 g/m² or 1 to 20 g/m², in particular of 1 to 15 g/m², more preferably of 2 to 10 g/m² or 7 to 20 g/m². The basis weights may also be 1 to 10 g/m², 5 to 10 g/m² or 5 to 15 g/m². The starting film web may have thicknesses in the range of 2 to 30 μm, in particular of 2 to 15 μm, 5 to 20 μm or 5 to 10 μm.

In the process according to the invention, heating of the starting film web is performed up to or above the molten liquid state of the low-melting polymer component and below the molten liquid state of the high-melting polymer component. Up to the molten liquid state means in this context that the low-melting polymer component is in a molten liquid state. It is, however, only heated to such a degree that the high-melting polymer component is not in the molten liquid state.

In order to make it possible to conduct the process in a stable manner, even for a prolonged period of time, the (crystallite) melting points of the low- and high-melting polymer components should appropriately not be too close to one another. Preferably, the crystallite melting point of the low-melting polymer component, or, in the presence of a plurality of low-melting polymer components, the crystallite melting point of those having the highest crystallite melting point, is at least about 5° C., preferably at least about 10° C. and in particular at least about 20° C. below the crystallite melting point or the molten liquid state of the high-melting polymer component or, in the presence of a plurality of high-melting polymer components, the crystallite melting point of those having the lowest crystallite melting point.

In order attain the molten liquid state of the low-melting polymer component but not the molten liquid state of the high-melting polymer component, the specifically-selected difference in temperature is not subject to any specific restrictions, provided the aforesaid condition has been met. The selected temperature difference is advantageously determined by practical considerations regarding safety of the process implementation or by economic considerations. If, for example, the low-melting polymer component is melted at a certain temperature, further increase in temperature will not give rise to better results. Moreover, heat consumption will increase, and it is possible that one comes too close to the melting range of the high-melting polymer component, such that the process is more difficult to perform. Preferably, the process of the invention is therefore performed in such a manner that heating of the starting film web is performed to 5 to 20° C., preferably 5 to 15° C. or 10 to 20° C., in particular, 10 to 15° C. or 15 to 20° C., below the crystallite melting point of the high-melting polymer component. In the alternative, heating is performed, in particular at a temperature in the range of from 1 to 20° C., preferably 2 to 10° C., above the crystallite melting point or the molten liquid state of the low-melting polymer component(s). It must be ensured that the crystallite melting points of the low-melting polymer component(s) are attained.

According to the invention, heating of the starting film web may be performed by means of at least one heating roller. Preferably, heating is performed by means of one or more heating rollers, which may be contact rollers heated to the predetermined temperature by means of a heat carrier, such as steam, water, oil. In a preferred embodiment, a single heating or contact roller is employed. It is, however, also possible to use two or more heating rollers, in which case it is necessary to ensure that the molten liquid state of the low-melting polymer component is attained upstream of the cooling roller nip. In order to ensure that the starting film web does indeed attain the temperature of the heating roller or that, in the case of high production velocities (where the surface temperature of the heating cylinder is higher than that of the film), the molten liquid state of the low-melting polymer component is attained with certainty, an adequate residence time of the starting film web on the heating roller surface must be ensured. This can be attained by an appropriate wrapping path of the heating cylinder, the diameter of the heating roller and/or the film web velocity as a function of the film thickness. It may be appropriate to use a heating roller with an anti-adhesion coated surface, in order to permit easier detachment of the film web from the heating roller and thus prevent tearing-off of the film web. Thus, displacement of the detachment point in the direction of rotation of the heating roller is avoided and no or only a small lead is necessary. For this purpose, a PTFE (polytetrafluoroethylene) coated heating roller is used, for example.

Heating of the film web may also be performed with other heating methods such as radiant heat, e.g. using infrared heating or infrared radiators. In addition to one or more heating rollers, a different heating, e.g. infrared heating, may be provided.

In a preferred embodiment, the filled stretched film web is heated to the partly molten state in the absence of a non-woven web. Unlike in EP 1 784 306 A1, in the present case, heating into the partly molten state can be performed without a non-woven web between the heating cylinder and the film web. In preferred embodiments, the microporous starting film web is heated by means of a heating cylinder, with no non-woven being present between the heating cylinder and the film web. In these embodiments, the film web is in direct contact with the heating cylinder. It is also possible that no non-woven is present between the heating cylinder and the film web, and a non-woven web rests on the film web or is passed over it. In other preferred embodiments, the heating of the microporous starting film web is carried out by means of a heating cylinder in the absence of a non-woven. This means that there is no non-woven between the heating cylinder and the film web and no non-woven rests on the film web. In alternative embodiments, a non-woven is present between the heating cylinder and the film web.

According to the invention, the film web is passed through a cooled roller nip after heating. The rollers forming the cooling roller nip are cooled in such a manner that rapid and sudden cooling is attained. Cooling to a temperature below the crystallite melting point of the low-melting polymer component, preferably to at least 5° C. below that melting point, in particular to at least 10° C. below that melting point, is appropriate. Preferred cooling ranges are 5 to 10° C., more preferably 10 to 30° C. below the crystallite melting point of the low-melting polymer component. Cooling of the rollers with water may, for example, take place in a temperature range of 5 to 20° C., e.g. using water having a temperature of about 10° C. The spacing between the heating roller or, if a plurality of heating rollers are used, the last heating roller and/or other heating sources and the cooling roller nip is not too wide in this context, due to possible heat loss.

The cooling roller nip may in the simplest case be, for example, a smooth-roller nip with two smooth rollers. In the case of hygiene films, the roller nip is, however, preferably formed by a pair of rollers with one texturing roller and one smooth roller (i.e. a rubber roller), thereby imparting a textured surface to the film web. Preferred textures in the hygiene field are micro-textures, e.g. a truncated pyramid. Preferably, the cooled roller nip consists of a steel roller and a rubber roller operating under counter-pressure, the steel roller being provided with the textured surface. The steel roller may be provided with a textile-like engraving which reinforces the textile appearance of the surface of the film. An embossed structure of the steel roller further reduces the shininess of the film.

The velocity of the rollers forming the cooling roller nip may be selected such that said velocity is the same as that of the heating roller or, if a plurality of heating rollers are used, the same as that of the last heating roller, such that the film is not stretched between them. The velocity of the rollers forming the cooling roller nip may also be selected such that said velocity is higher or lower than that of the heating roller or, if a plurality of heating rollers are used, that of the last heating roller, such that the film is stretched or shrunk between them. Due to heat loss, the spacing between the heating roller and the cooling roller nip should be kept as small as possible.

Depending on the film parameters and other process conditions, the film web velocities are in the range of 50 to 900 m/min. The velocity of the heating roller(s) is preferably 50 to 900 m/min, in particular 50 to 800 m/min, preferably 100 to 600 m/min. The velocity of the rollers forming the cooling roller nip is preferably 50 to 900 m/min, in particular 50 to 800 m/min, preferably 100 to 600 m/min. The velocities of the heating roller(s) and the cooling rollers are selected such that, depending on the film formulation and the selected process parameters, said velocities are the same or, however, different, so that the film is stretched or shrunk (annealing) in the desired ratio.

The process according to the invention enables the manufacture of films having very small basis weights of e.g. 2, 3, 4, 5, 6, 7, 8, 9, 10, 11, 12, 13, 14, 15, 16, 17, 18, 19, 20 or 25 g/m². The corresponding film thicknesses preferably lie within the range of e.g. 25, 20, 19, 18, 17, 16, 15, 14, 13, 12, 11, 10, 9, 8, 7, 6 or only 5 μm. Preferred films have a thickness in the range of 2 to 13 μm or 4 to 25 μm or have a basis weight of 1 to 15 g/m² or of 4 to 25 g/m² or of 7 to 20 g/m².

Despite being very thin and macroporous, the films obtained according to the invention have excellent mechanical properties and, in addition, still have a very high puncture resistance (i.e. resistance to super-absorber granules, e.g. in diapers) and high thermo-stabilities (i.e. resistance to hot melt-adhesives).

Films obtained according to the invention may be further processed in a known manner. For example, single back sheets or non-woven fabric-film laminates can be produced therefrom. For manufacturing non-woven fabric-film laminates, the films may be adhesively-bonded to non-wovens by adhesive agents, preferably in-line. Apart from that, non-woven fabric-film laminates may also be manufactured by thermo-bonding, known to the person skilled in the art, in which case the material of a film and/or non-woven fabric obtained according to the invention is melted by high temperature and pressure at particular points by means of two heated rollers, in most cases an embossing roller (engraved steel roller) and a smooth steel roller serving as counter-roller, thereby causing the film and non-woven fabric to be bonded together. Moreover, non-woven fabric-film laminates, as described above, may also be manufactured by thermo-laminating. Thermo-laminating is particularly preferred in the case of very thin films, e.g. under 10 g/m² or e.g. 4 g/m². In addition, non-woven fabric-film laminates may also be produced by means of ultrasonic lamination (e.g. using ultrasound Herrmann technology). The non-woven fabric-film laminates produced may be further processed in a manner known per se, in which case stretching in the machine or transverse direction or in both directions is likewise possible. Single back sheets may also be processed further.

FIG. 1 shows a preferred embodiment for carrying out the process according to the invention. A filled film A, e.g. from the extruder, passes through a stretching unit with the rollers 1, 2 and 3; this way the film becomes microporous. The three rollers may, for example, be operated at roller velocities of 100/200/200 m/min or 100/150/200 m/min. Over the deflecting rollers 4, 5 and 6, the microporous starting film web B is passed onto a heating roller 7. The heating roller 7 may be, for example, an anti-adhesively coated steel roller, which is heated to the desired surface temperature by heat supply. The film web then runs on the heating roller 7, thereby being heated into the partly molten liquid state according to the invention. From the heating roller 7, the partly molten liquid film web C runs into a cooling roller nip formed by the rollers 8 and 9. The roller 8 is preferably designed as a structure or embossing roller, thereby imparting an embossed structure or structured surface to the film web. The roller 9 is preferably a rubber roller. The roller pair 8/9 is preferably water-cooled, e.g. with water having a temperature of about 10° C. The rollers 8 and 9 forming the cooling nip are driven such that a higher, lower or the same velocity arises in relation to the web velocity of the heating roller 7. In the cooling roller nip, the film web is abruptly cooled and embossed. After the roller pair 8/9, the film can be directly taken off, or, via the deflecting rollers 10 and 11, which may also be cooled, the film web D may be fed into a printing unit with the rollers 12 in order to be printed. Afterwards, the film E may be taken off.

Due to the manufacture of films with extremely thin thicknesses, the invention enables raw material savings, thereby contributing to saving resources and sustainability. As a result, it contributes to protecting the environment. This applies to films in the hygiene sector and to other applications, especially applications where the films are used to a large extent as components of disposable products.

In view of the problems in the prior art described above, the film manufactured according to the invention offers numerous improvements and advantages:
The film allows a high temperature load, e.g. with hot melt adhesives.
The film shows almost no post-shrinkage.
Due to its embossed structure, the film can also prevent blocking since this structure acts as a spacer between the film layers and thus prevents the individual film layers from sticking together.
On the one hand, due to its embossed structure, the film may also prevent the individual film layers from sticking together and, on the other hand increase the flatness of the film as the embossed structure compensates for thick and thin spots. Any edge thickening due to neck-in may be smoothed out by means of the setting of the embossing.
The film has an increased tear propagation strength (due to “soft annealing” of the film after the stretching process). The three-dimensional embossing structure prevents the film from tearing easily as a film orientation in the z direction is provided by the embossing structure.
The film has increased puncture resistance. The three-dimensional embossing structure prevents the film from tearing easily at particular points above the super-absorber granules as a film orientation in the z direction is provided by the embossing structure.
Pores which are too large may shrink and thus high liquid impact values may be reduced. This means that pores >1 μm which are too large may be shrunk to a size of <1 μm by the process according to the invention. In the embossing unit, an embossing structure is imprinted on the film by means of the adjusted pressure and the abrupt cooling, and the pore size is simultaneously frozen and thus fixed.
Since the films show hardly measurable post-shrinkage, they can be imprinted inline directly after the stretching process, for example by means of an intermediate “hot embossing process”.
At high thermal loads, for example when hot melt adhesive systems are applied, the film shows higher resistance and low shrinking behavior, respectively, and smaller so-called burn-through effects, respectively; this way, the formation of holes is reduced or does not occur any longer.

The films obtained according to the invention can be used in many areas. They are used in the hygiene or medical field, e.g. as an underwear protection film or generally as a liquid-impermeable barrier layer, in particular as back sheets in diapers, sanitary napkins, mattress protectors or similar products. Furthermore, the films can be used in other technical fields, for example in the construction sector as construction films, e.g. for roof lining webs, screed coverings or wall coverings, or as car protection films in the automotive area.

Films obtained according to the invention may be further processed in a known manner, for example into non-woven fabric-film laminates. For manufacturing such laminates, the latter may be adhesively-bonded by adhesive agents, preferably in-line. Apart from that, non-woven fabric-film laminates may also be manufactured by thermo-bonding, known to the person skilled in the art, in which case the material of a film and/or non-woven fabric obtained according to the invention is melted by high temperature and pressure at particular points by means of two heated rollers, in most cases an embossing roller (engraved steel roller) and a smooth steel roller serving as counter-roller, thereby causing the film and non-woven fabric to be bonded together. Moreover, non-woven fabric-film laminates may also be manufactured by thermo-laminating, for example as described in EP 1 784 306 B1. Thermo-laminating is particularly preferred in the case of very thin films, e.g. under ₄ g/m². Alternatively, non-woven fabric-film laminates may also be produced by means of ultrasonic lamination (e.g. using ultrasound Herrmann technology). The manufactured non-woven fabric-film laminates may be further processed in a manner known per se.

The invention is explained in detail by way of the following example, without limiting the invention.

### EXAMPLES

The examples illustrate the production of films according to the invention and show their behavior during heat shrinkage.

### Example 1

The films are produced by blow-extruding a chalk-filled film from two different polypropylene compounds according to customary processes. The two polypropylene compounds have different melting points/ranges. The higher melting polypropylene compound contains 92.5% by weight of polypropylene (PP) and 7.5% by weight of ethylene copolymer. It has a DSC melting point of about 164° C. and is used in an amount of 16% by weight, based on 100% by weight of the used polymer material (i.e. without filler). The low-melting polypropylene compound contains 90.5% by weight of PP and 9.5% by weight of ethylene copolymer. It has a DSC melting point of about 138° C. and is used in an amount of 80% by weight, based on 100% by weight of the used polymer material. Each compound has a chalk content of about 60% (based on 100% by weight of compound). 4% by weight of an LDPE (DSC melting point of 111° C.), based on 100% by weight of the polymer material used, are added.

After the extrusion process, the filled, extruded film is fed into a stretching embossing printing machine according to FIG. 1. In the course of this, the film A is stretched approximately 2:1 in the machine direction by means of the tempered stretching rollers 1/2/3 in order to produce the breathability. Subsequently, the breathable film B is heated by means of the heating cylinder 7 at different heating cylinder temperatures, as indicated in Table 1 below. After heating of the film by means of the heating cylinder 7, the film C is, while maintaining this state, fed to the embossing unit (embossing roller 8 and rubber roller 9) and provided with an embossed structure therein. The embossing rubber rollers are strongly cooled (<30° C.) and are subjected to a mutual adjusted pressure of several tons, for example at values of 4 to 10 tons of adjusted pressure on each roller side. The film D leaves the embossing unit in an abruptly cooled and embossed state.

Tablet 1 indicates how a film behaves during heat shrinkage as a function of the heating cylinder temperature used.

The heat shrinkage was determined as follows according to ASTM D2732-96.

Description

When examining the heat shrinkage according to ASTM D2732-96, the degree of material orientation is determined.

This involves heating a defined sample (10×10 cm) in a water bath at 80° C. and cooling it again after 30 seconds.

The length difference of the sample in % is indicated as the shrinkage value.

Test Equipment

Shrinkage bath, measuring tape

Sample Preparation

A square of 100×100 mm is drawn on the samples by means of a sheet metal square and checked with a measuring tape.

The samples are to be marked with longitudinal and transverse direction, respectively.

Performing

Setting shrinkage bath to 80° Celsius.

Immerse samples in the heated water bath, remove carefully after 30 seconds and allow to cool (water bath in a basin).

Evaluation

Shrinkage values longitudinal and transverse: the difference between the originally marked measuring length and the shrunken measuring length corresponds to the shrinkage value in %.

The measurement results according to Table 1 were obtained at the indicated heating cylinder temperatures. The indicated heating cylinder temperatures refer to a measurement on the inside of the heating cylinder via a temperature sensor (platinum measuring resistor, Pt100 element). The shrinkage direction given in Table 1 indicates the direction in which the shrinkage of the film was measured (machine direction MD or transverse direction CD).

TABLE 1

| Heating cylinder | | | Shrinkage in the |
|---|---|---|---|
| temperature | Basis weight | Shrinkage | water bath at |
| [° C.] | [g/m²] | direction | 80° C. [%] |
| 140 | 19.4 | MD | 1.6 |
| | | CD | 0.3 |
| 137 | 18.8 | MD | 2.5 |
| | | CD | 0.7 |
| 135 | 19.4 | MD | 2.5 |
| | | CD | 0.7 |
| 133 | 19.0 | MD | 3.9 |
| | | CD | 0.7 |
| 131 | 19.0 | MD | 4.4 |
| | | CD | 0.5 |
| 129 | 19.4 | MD | 5.3 |
| | | CD | 0.6 |
| 127 | 19.7 | MD | 7.5 |
| | | CD | 0.2 |
| 125 | 19.7 | MD | 7.5 |
| | | CD | 0.3 |
| 123 | 19.4 | MD | 8.3 |
| | | CD | 0.2 |
| 121 | 20.0 | MD | 9.6 |
| | | CD | 0.2 |
| Without heating cylinder | 22.0 | MD | 24.1 |
| and cooling (embossing) | | CD | 0.2 |

Table 1 clearly shows how the post-shrinkage decreases when the film is guided into the partly molten state while the heating cylinder temperature rises. The results are also shown graphically in FIG. 2 as a diagram. On the one hand, the diagram shows, as a function of the heating cylinder temperature, the basis weight of the film (upper part of the diagram, dashed line) and, on the other hand, the heat shrinkage (in a water bath of 80° C.) in the MD direction (dotted line) and in the CD direction (solid line). The value for the shrinkage indicated in Table 1 when working without a heating cylinder and a cooling (embossing) is not shown in FIG. 2. The value in Table 1 clearly shows how high the shrinkage is if the process according to the invention is not carried out.

### Example 2

A film was produced according to the method described in Example 1 at a heating cylinder temperature of 135° C. using a basis weight of 16 g/m². This film was compared with a film from the prior art (comparison film) with a basis weight of 22 g/m² with regard to the heat shrinkage at various water bath temperatures, as indicated in Table 2. The shrinkage measurement was carried out analogously to Example 1. The results are shown in Table 2.

TABLE 2

| Water bath | | | |
|---|---|---|---|
| temperature | Shrinkage | Shrinkage [%] | |
| [° C.] | direction | Film [16 g/m²] | Comparison [22 g/m²] |
| <40 | MD | 0 | 0 |
| | CD | 0 | 0 |
| 40 | MD | 0 | 1.1 |
| | CD | 0 | 0 |
| 50 | MD | 0 | 2.2 |
| | CD | 0 | 0 |
| 60 | MD | 0.6 | 3.8 |
| | CD | 0 | 0 |
| 70 | MD | 1.2 | 9.1 |
| | CD | 0.7 | 0 |
| 75 | MD | 2.0 | 11.3 |
| | CD | 0.3 | −0.5 |
| 80 | MD | 2.0 | 13.1 |
| | CD | 0-0.2 | −1.6 |

The results of Table 2 are also graphically illustrated in FIG. 3 for the MD shrinkage direction. The diagram of FIG. 3 shows the shrinkage in the MD direction for the film according to the invention (dashed line) and the comparison film (comparison, solid line) as function of the indicated water bath temperature.

It can be seen from Table 2 that the film according to the invention exhibits much lower heat shrinkage than the comparison product. The film according to the invention therefore offers great advantages at high temperatures as may occur in storage rooms or ships, for example. At high thermal loads, for example when hot melt adhesive systems are applied, it would show higher resistance and low shrinking behavior, respectively, and smaller so-called burn-through effects, respectively.

1. A process for producing a filled film web from a microporous starting film web of thermoplastic polymer material, which comprises at least one low-melting polymer component, one high-melting polymer component and a filler, the process comprising the following steps:
heating of the microporous starting film web to a partly molten state in which at least one low-melting polymer component exists in a molten liquid state and at least one high-melting polymer component does not exist in the molten liquid state, and
cooling down by passing the partly molten film web through a cooled roller nip.

2. The process according to claim 1, characterized in that the microporous starting film web is single-layered.

3. The process according to claim 1, characterized in that the microporous starting film web is multi-layered, in particular in that the microporous starting film web is a co-extruded film web.

4. The process according to claim 1, characterized in that the microporous starting film web has been stretched, in particular in that the starting film web after its extrusion has been stretched at a stretching ratio of 1.2:1 to 4:1.

5. The process according to claim 1, characterized in that the microporous starting film web contains 10 to 90% by weight of filler, based on 100% by weight of the starting film web.

6. The process according to claim 1, characterized in that the microporous starting film web is breathable.

7. The process according to claim 1, characterized in that the microporous starting film web has a water vapor permeability within the range of from 500 to 5000 g/m² in 24 hours when measured according to ASTM E398 at 37.8° C. and 90% relative humidity.

8. The process according to claim 1, characterized in that the microporous starting film web comprises 15 to 85% by weight of low-melting polymer component and 85 to 15% by weight of high-melting polymer component, based on 100% by weight of low-melting and high-melting polymer components.

9. The process according to claim 1, characterized in that a starting film web with at least one polyethylene serving as a low-melting polymer component and with at least one polypropylene serving as a high-melting polymer component is used.

10. The process according to claim 1, characterized in that the heating of the microporous starting film web is performed by means of a heating cylinder, wherein a non-woven is not present between the heating cylinder and the film web.

11. The process according to claim 1, characterized in that the microporous starting film web has been produced by blown film extrusion, cast extrusion, or by blown film extrusion and cast extrusion.

12. The process according to claim 1, characterized in that the film web is subjected to cooling in the cooled roller nip to at least 10 to 30° C. below the crystallite melting point of at least one low-melting polymer component.

13. A film web obtainable by a process according to claim 1.

14. The film web according to claim 13, having a basis weight within the range of from 1 to 30 g/m².

15. Use of the film web according to claim 13 in the hygiene or medical field.

16. Use of the film web according to claim 13 in the construction area or as automobile protection film.

17. The process according to claim 1, characterized in that the microporous starting film web has been stretched, in particular in that the starting film web after its extrusion has been stretched at a stretching ratio of 1.5:1 to 3:1.

18. The process according to claim 1, characterized in that the microporous starting film web contains 20 to 80% by weight of filler, based on 100% by weight of the starting film web.

19. The process according to claim 1, characterized in that the microporous starting film web contains 30 to 75% by weight of filler, based on 100% by weight of the starting film web.

20. The film web according to claim 13, having a basis weight within the range of from 5 to 25 g/m².

21. The film web according to claim 13, having a basis weight within the range of from 7 to 20 g/m².

22. The film web according to claim 13, having a basis weight within the range of from 10 to 20 g/m².
